(19) United States
(12) Patent Application Publication
(10) Pub. No.: US 2022/0194455 A1
(43) Pub. Date: Jun. 23, 2022

(54) TRAVELING TOOL FOR CART AND CARRYING TOOL

(71) Applicant: HONDA MOTOR CO., LTD., Tokyo (JP)

(72) Inventors: Shota Shimotani, Wako-shi (JP); Yuki Satoh, Wako-shi (JP); Shunsuke Sawasaki, Wako-shi (JP); Tokio Unno, Wako-shi (JP); Izuru Koyama, Wako-shi (JP)

(73) Assignee: HONDA MOTOR CO., LTD., Tokyo (JP)

(21) Appl. No.: 17/551,411

(22) Filed: Dec. 15, 2021

(30) Foreign Application Priority Data
Dec. 22, 2020 (JP) 2020-212655

(51) Int. Cl. B62B 5/08; B62B 3/02; B62B 5/00

(52) U.S. Cl. CPC B62B 5/087; B62B 2207/00; B62B 5/0026; B62B 3/02

(57) ABSTRACT

The present invention provides a traveling tool for a cart being to be attached to a cart, the traveling tool including a deck portion including a board-like member that defines a footrest surface on which a foot of the user is to be placed, at least one first wheel provided in rear of the deck portion so as to enable the deck portion to travel, an operation pole provided on front of the deck portion so as to enable the deck portion to he rotated, and a coupling portion that is provided on the operation pole, and couples the deck portion to the cart.

### CROSS-REFERENCE TO RELATED APPLICATION(S)

This application claims priority to and the benefit of Japanese Patent Application No. 2020-212655 filed on Dec. 22, 2020, the entire disclosure of which is incorporated herein by reference.

### BACKGROUND OF THE INVENTION

### Field of the Invention

The present invention relates to a traveling tool for a cart, and a carrying tool.

### Description of the Related Art

In various environments such as companies, homes, factories, and stores, carts are widely used as carrying tools for efficiently and safely carrying articles, that is, objects to be carried. A cart allows a user to carry an object to be carried, (by human power) by placing the object to be carried on a wheeled platform and pushing a handle provided on the rear side of the platform while walking.

The cart is useful for carrying an object to be carried. However, the cart has a certain size. Thus, the size of the cart is disadvantageous in terms of space when the cart is not used, for example, when the cart is stored. In view of the above, Japanese Patent Laid-Open No. 62-218264 proposes a technique that enables a cart to be made compact in size when the cart is not used.

However, there is a demand for a technique for improving user convenience (usability) of a cart by not only reducing the size of the cart when the cart is not used, but also reducing a load on a user at the time of carrying an object to be carried. In particular, in the case of carrying an object to be carried for a long distance, it takes time to carry the object to be carried, and this significantly increases user's fatigue. Therefore, a technique for improving such a situation has been required.

### SUMMARY OF THE INVENTION

The present invention provides a new technique related to improvement in usability of a cart.

According to one aspect of the present invention, there is provided a traveling tool for a cart, the traveling tool being to be attached to a cart, the cart including a wheeled platform on which an object to he carried is to be placed, the object to be carried being to be carried by a user pushing a handle provided in rear of the platform, the traveling tool including a deck portion extending in a first direction and including a board-like member that defines a footrest surface on which a foot of the user is to be placed, at least one first wheel provided in rear of the deck portion, the at least one first wheel being attached to the board-like member in such a way as to be capable of rotating around an axis so as to enable the deck portion to travel, the axis being along a second direction orthogonal to the first direction, an operation pole provided on front of the deck portion so as to enable the deck portion to be rotated around an axis with respect to the cart, the axis being along a third direction orthogonal to the first direction and the second direction, and a coupling portion that is provided on the operation pole, and couples the deck portion to the cart.

Further aspects of the present invention will become apparent from the following description of exemplary embodiments with reference to the attached drawings.

### BRIEF DESCRIPTION OF THE DRAWINGS

FIG. 1 is a schematic diagram illustrating a configuration of a carrying tool according to a first embodiment of the present invention;

FIG. 2 is a diagram for describing a function of an operation pole of the carrying tool illustrated in FIG. 1;

FIG. 3 is a diagram illustrating a state in which the carrying tool illustrated in FIG. 1 has been compactly folded; and

FIG. 4 is a schematic diagram illustrating a configuration of a carrying tool according to a second embodiment of the present invention.

### DESCRIPTION OF THE EMBODIMENTS

Hereinafter, embodiments will be described in detail with reference to the attached drawings. Note, the following embodiment's are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

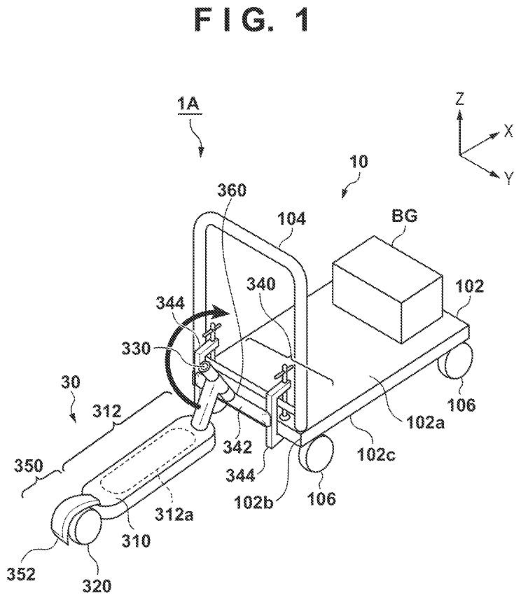

FIG. 1 is a schematic diagram illustrating a configuration of a carrying tool 1A according to a first embodiment of the present invention. The carrying tool 1A is, for example, a tool for carrying an object BG to be carried from one place to another in various environments such as companies, homes, factories, and stores. The carrying tool 1A is basically configured as if a cart and a scooter have been combined, and includes a cart 10 and a traveling tool 30 for a cart.

Note that, in order to facilitate understanding of the structure, an X-axis, a Y-axis, and a Z-axis orthogonal to each other are illustrated in FIG. 1. A direction (X direction) parallel to the X-axis corresponds to a front-and-tear direction of the carrying tool 1A. A direction (Y direction) parallel to the Y-axis corresponds to a right-and-left direction (width direction) of the caning tool 1A. A direction (Z direction) parallel to the Z-axis corresponds to an up-and-down direction (height direction) of the carrying tool 1A. In addition, terms such as front/rear, right left, and up down refer to relative positional relationships with respect to the carrying tool 1A. For example, terms such as “front” and “on the front of” correspond to the +X direction, and terms such as “rear” and “in the rear of ” correspond to the −X direction.

The cart 10 is a cart to be pushed by hand so that the object BG to be carried is carried by human power (by hand). The cart 10 includes a platform 102, a handle 104, and wheels (casters) 106.

The platform 102 defines, on its upper surface 102a, a placement surface on which the object BG to be carried is to be placed. In the present embodiment, the platform 102 has a substantially rectangular shape such as a rectangular shape with its long side along the front-and-rear direction (X direction) and its short side along the right-and-left direction (Y direction). However, the shape of the platform 102 is not limited thereto. In addition, the platform 102 is made of wood, metal, plastic, or the like in consideration of the type, weight, and the like of the object BG to be carried.

The handle 104 is provided in such a way as to stand straight (upright) in the rear of the platform 102. In the present embodiment, a pipe having a substantially inverted U-shape is provided as the handle 104 at a rear end portion 102b of the platform 102. The handle 104 is to be gripped and operated by a user so as to control the traveling and stopping of the cart 10 and a direction in which the cart 10 travels when the object BG to be carried is carried (when the cart 10 is caused to travel). Specifically, the user pushes the handle 104 in a direction (carrying direction) in which the object BG to be carried, placed on the platform 102 is to be carried. As a result, the user can cause the cart 10 to travel in the carrying direction. Note that the handle 104 may be provided at the rear end portion 102b of the platform 102 in such a way as to be capable of rotating around an axis along the right-and-left direction (Y direction) so that the handle can he folded toward (the upper surface 102a of) the platform 102.

The wheels 106 are provided on a lower surface 102c of the platform 102, specifically, at at least four corners of the lower surface 102c. The wheels 106 are each provided in such a way as to be capable of rotating around an axis along the right-and-left direction (Y direction) so as to enable the cart 10 to travel. Note that it is preferable that among the at least four wheels 106 provided on the lower surface 102c of the platform 102, the two wheels 106 located on the front side or the rear side of the platform 102 be each provided in such a way as to be capable of rotating around an axis along the height direction (Z direction). This makes it possible to easily change the direction in which the cart 10 travels when carrying the object BG to be carried.

The traveling tool 30 for a cart, is a unit that is attached to the cart 10 and assists the cart 10 in traveling (that is, assists the object BG to be carried in being carried). The traveling tool 30 for a cart is configured as if a handle and a front wheel have been removed from a general scooter. In the present embodiment, the traveling tool 30 for a cart includes a deck portion 310, a wheel (caster) 320, an operation pole 330, a coupling portion 340, and a brake portion 350.

The deck portion 310 is a main body (vehicle body) of the traveling tool 30 for a cart, and includes a board-like member 312. The board-like member 312 may include, for example, a combination of a frame and a board attached to the frame, or may include a single board member. The board-like member 312 extends in the front-and-rear direction (X direction), and defines a footrest surface 312a on which the user places his/her foot. In the present embodiment, the footrest surface 312a is configured such that the user can place at least one foot. In other words, the board-like member 312 defines the footrest surface 312a such that the footrest surface 312a has an enough area for the user to place one foot. As a result, it is possible for the user to stand with one foot placed on the footrest surface 312a of the deck portion 310 (the board-like member 312) and the other foot pushing against a ground surface (a road, the ground, a floor, or the like) with which the wheel 320 of the traveling tool 30 for a cart is in contact.

The wheel 320 (first wheel) is provided in the rear of the deck portion 310 so as to enable the traveling tool 30 for a cart to travel. In the present embodiment, a single wheel 320 is provided at a rear end portion of the board-like member 312 in such a way as to be capable of rotating around an axis along the right-and-left direction (Y direction). However, the number of the wheels 320 to be provided on the deck portion 310 is not limited to one as long as at least one wheel 320 is provided on the deck portion 310. For example, two wheels 320 may be provided in the rear of the deck portion 310. Furthermore, in addition to the wheel 320 provided in the rear of the deck portion 310, an additional wheel may be provided on the front of the deck portion 310.

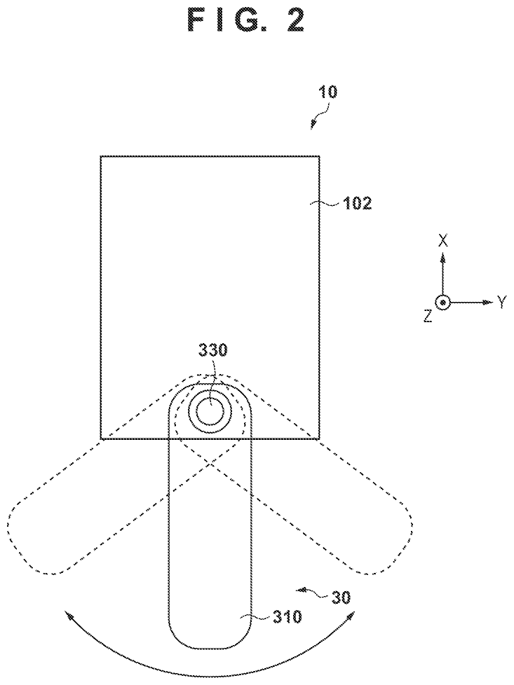

The operation pole 330 is provided on the front of the deck portion 310. In the present embodiment, the operation pole 330 is provided at a front end portion (end portion closer to the cart 10) of the board-like member 312. For example, as illustrated in FIG. 1, the operation pole 330 includes a cylindrical pipe member made of metal (iron or the like), and has been inserted in a through hole provided in the front end portion of the board-like member 312. Therefore, as illustrated in FIG. 2, the operation pole 330 has a function of enabling the deck portion 310 to rotate around an axis along the Z direction (a third direction orthogonal to the front-and-rear direction (X direction) that is a first direction and the right-and-left direction (Y direction) that is a second direction) with respect to the cart 10. It is possible to ensure rotational movement of the traveling tool 30 for a cart (deck portion 310) in the right-and-left direction by providing the operation pole 330 in this manner. FIG. 2 is a diagram for describing a function of the operation pole 330.

The coupling portion 340 couples the traveling tool 30 for a cart (deck portion 310) to the cart 10 (platform 102), on the front of the deck portion 310, specifically, at the front end portion of the board-like member 312. The coupling portion 340 is provided on the operation pole 330, and is fixed to the operation pole 330 in the present embodiment. As a result, the coupling portion 340 can firmly couple the traveling tool 30 for a cart to the cart 10 via the operation pole 330.

A specific configuration of the coupling portion 340 will be described. In the present embodiment, the coupling portion 340 includes a bar member 342 made of metal (iron or the like) and clamps (C clamps) 344. As illustrated in FIG. 1, the central portion of the bar member 342 is fixed to the operation pole 330 such that the bar member 342 extends in the right-and-left direction (Y direction). The clamp 311 is provided at each of the left end portion and right end portion of the bar member 342, and holds the upper surface 102a and the lower surface 102c of the platform 102. With such a configuration, the traveling tool 30 for a cart can be easily coupled to the cart 10, that is, the traveling tool 30 for a cart can be easily attached to the cart 10. In addition, since the traveling tool 30 for a cart can be detachably coupled to the cart 10 by use of the clamps 344, a commercially available general cart can be used as the cart 10, and when the traveling tool 30 for a cart is not necessary, the traveling tool 30 for a cart can be easily removed from the cart 10.

The brake portion 350 has a function of decelerating or stopping the traveling of the traveling tool 30 for a cart (deck portion 310) by applying resistance to rotation of the wheel 320 provided on the deck portion 310. In the present embodiment, the brake portion 350 includes a brake shoe 352 provided at the rear end portion of the board-like member 312. When the user steps on the brake shoe 352 with one foot, the brake shoe 352 comes into contact with the wheel 320, and can apply resistance to rotation of the wheel 320. Note that there is an appropriate clearance between the brake shoe 352 and the wheel 320 such that the brake shoe 352 is not in contact with the wheel 320 unless the user steps on the brake shoe 352 with one foot. It is possible to easily control the deceleration or stopping of the traveling of (the carrying tool 1A including the cart 10 and) the traveling tool 30 for a cart by providing the brake portion 350. This is particularly useful in the case of an emergency or the like in which it is necessary to immediately stop the traveling tool 30 for a cart.

As described above, according to the carrying tool 1A with a configuration in which the traveling tool 30 for a cart, is attached to the cart 10, when the user grips the handle 104 of the cart 10 by hand, and stands with one foot placed on the footrest surface 312a of the deck portion 310 and the other foot pushing against the ground surface, the wheel 320 provided on the deck portion 310 rotates to cause the traveling tool 30 for a cart (deck portion 310) to travel, and the cart 10 coupled to the deck portion 310 via the coupling portion 340 travels in conjunction with the traveling of the traveling tool 30 for a cart. Therefore, in the present embodiment, it is possible to reduce a load on the user at the time of carrying the object BG to be carried and improve user convenience (usability) as compared with a case where the user pushes the handle 104 of the cart 10 by hand (with the strength of the user's arms) while walking (a case where the traveling tool 30 for a cart is not attached). In addition, in the present embodiment, since (the carrying tool 1A including the traveling tool 30 for a cart and the cart 10 is caused to travel by the strength of the user's legs, the time required for carrying the object BG to be carried can be shortened, so that it is possible to reduce user's fatigue caused by the carrying of the object BG to be carried. Furthermore, in addition to reducing a load on the user at the time of carrying the object BG to be carried, the carrying tool 1A according to the present embodiment also serves as a vehicle that provides enjoyment for the act of carrying the object BG to be carried that is more likely to be avoided than

Meanwhile, the carrying tool 1A includes the traveling tool 30 for a cart in addition to the cart 10. This brings a disadvantage in terms of space when the carrying tool 1A is not used, for example, when the carrying tool 1A is stored. However, as described above, the traveling tool 30 for a cart is detachably coupled to the cart 10 via the coupling portion 340. Therefore, the traveling tool 30 for a cart just needs to be removed from the cart 10 when the carrying tool 1A is stored.

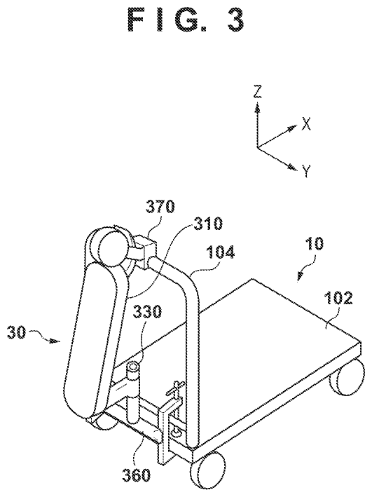

In addition, as illustrated in FIG. 1, a rotation portion 360 may be provided at the front end portion (end portion closer to the cart 10) of the deck portion 310, specifically, the board-like member 312 of the traveling tool 30 for a cart. The rotation portion 360 enables the deck portion 310 to rotate around an axis along the right-and-left direction (Y direction) with respect to the cart 10. Specifically, the rotation portion 360 rotates the deck portion 310 in an arrow direction illustrated in FIG. 1 with respect to the cart 10. As a result, when the carrying, tool 1A is stored, it is possible to compactly fold the carrying tool 1A by rotating the deck portion 310 in such a way as to position the deck portion 310 close to the cart 10 (the handle 104 in the present embodiment), as illustrated in FIG. 3. Note that it is also possible to achieve further compactness by applying, to the cart 10, a conventional technique that enables the platform 102 and the handle 104 to be folded. FIG. 3 is a diagram illustrating a state in which the carrying tool 1A has been compactly folded.

Furthermore, when the rotation portion 360 is provided, it is preferable to further provide a fixing: portion 370 that fixes, to the cart 10 (the handle 104 in the present embodiment), the deck portion 310 rotated by the rotation portion 360 in such a way as to be positioned close to the cart 10, as illustrated in FIG. 3. As a result, it is possible to keep the carrying tool 1A compactly folded.

### Second Embodiment

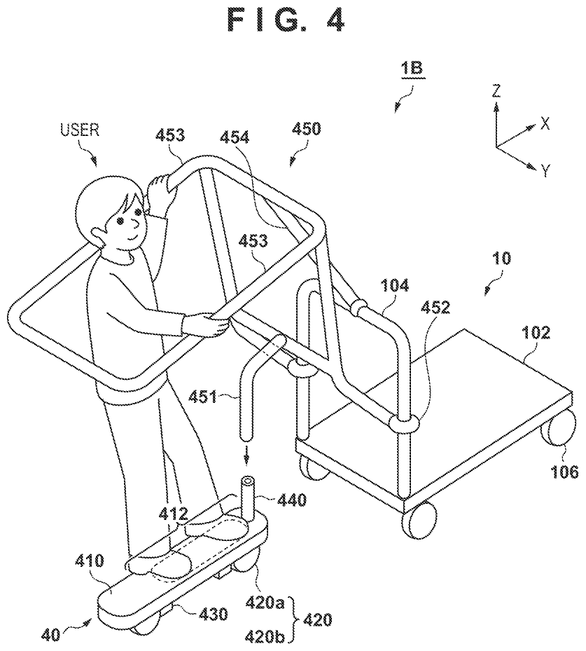

FIG. 4 is a schematic diagram illustrating a configuration of a carrying tool 1B according to a second embodiment of the present invention. As with the carrying tool 1A, the carrying tool 1B is a tool for carrying an object BG to be carried. The carrying tool 1B is basically configured as if a cart and an electric scooter have been combined, and includes a cart 10 and a traveling tool 40 for a cart.

Note that, in order to facilitate understanding; of the structure, an X-axis, a Y-axis, and a Z-axis orthogonal to each other are illustrated in FIG. 4. A direction (X direction) parallel to the X-axis corresponds to a front-and-rear direction of the carrying tool 1B. A direction (Y direction) parallel to the Y-axis corresponds to a right-and-left direction (width direction) of the carrying tool 1B. A direction (Z direction) parallel to the Z-axis corresponds to an up-and-down direction (height direction) of the carrying tool 1B. In addition, terms such as front/rear, right/left, and up/down refer to relative positional relationships with respect to the carrying tool 1B.

The traveling tool 40 for a cart is a unit that is attached to the cart 10 and assists the cart 10 in traveling (that is, assists the object BG to be carried in being carried). The traveling tool 40 for a cart is configured as if a handle has been removed from a general electric scooter. In the present embodiment, the traveling tool 40 for a cart includes a deck portion 410, wheels (casters) 420, a motor 430, an operation pole 440, and an attachment portion 450.

The deck portion 410 is a main body (vehicle body) of the traveling tool 40 for a cart, and includes a board-like member 412. The board-like member 412 may include, for example, a combination of a frame and aboard attached to the frame or may include a single board member. The board-like member 412 extends in the front-and-rear direction (X direction), and defines a footrest surface 412a on which a user places his/her foot. In the present embodiment, the footrest surface 412a is configured such that at least both feet of the user can be placed. In other words, the board-like member 412 defines the footrest surface 412a such that the footrest surface 412a has an enough area, for the user to place both feet. As a result, the user can stand on the footrest surface 412a of the deck portion 410 (the hoard-like member 412).

The wheel 420 is provided on each of the front side and the rear side of the deck portion 410 so as to enable the traveling tool 40 for a cart to travel. In the present embodiment, a single wheel 420a (second wheel) is: provided on the front of the board-like member 412 in such a way as to he capable of rotating around an axis along the right-and-left direction (Y direction), and a single wheel 420b (first wheel) is provided in the rear of the board-like member 412 in such a way as to be capable of rotating around an axis along the right-and-left direction (Y direction). However, the number of the wheels 420 to be provided on the deck portion 410 is not limited to two.

The motor 430 rotates at least either the wheel 420a or 420b around the axis along the right-and-left direction, Any technique known in the art can be applied to the motor 430. The motor 430 is embodied as, for example, an in-wheel motor incorporated in at least either the wheel 420a or 420b, together with a lithium-ion battery as a power source. Note that a power switch (not illustrated) for turning on/off the drive of the motor 430 (that is, for causing the traveling tool 40 for a cart to travel or stop) is provided on, for example, (the footrest surface 412a of) the deck portion 410 within a range where the power switch can be operated by the foot of the user.

The operation pole 440 is provided on the front of the deck portion 410. In the present embodiment, the operation pole 40 is provided at a front end portion (end portion closer to the cart 10) of the board-like member 412. The operation pole 140 includes, for example, a hollow cylindrical pipe member as illustrated in FIG. 4, and has a function of enabling the deck portion 410 to rotate around an axis along the Z direction (a third direction orthogonal to the front-and-rear direction (X direction) that is a first direction and the right-and-left: direction (Y direction) that is a second direction) with respect to the cart 10, as described with reference to FIG. 2, as a result of insertion of the attachment portion 450 (joining portion 451) to be described below into the operation pole 440. As described above, the operation pole 110 can cooperate with the attachment portion 450 to ensure rotational movement of the traveling tool 40 for a cart (deck portion 410) in the right-and-left direction.

The attachment portion 450 is attached to the operation pole 440 and a handle 104 of the cart 10, and functions as a coupling portion that couples the traveling tool 40 for a cart (deck portion 410) to the cart 10 (platform 102).

The attachment portion 450 includes the joining portion 451 on the traveling tool side and a joining portion 452 on the cart side. The joining portion 451 is to be attached to the operation pole 440 provided on the traveling tool 40 for a cart. The joining portion 452 is to be attached to the handle 104 of the cart 10. The joining portion 451 has a cylindrical shape having a diameter slightly smaller than the diameter of the operation pole 440 so as to be capable of being inserted into the operation pole 440. In addition, the joining portion 452 has a one-touch catch structure that enables the attachment portion 450 to rotate around an axis along the up-and-down direction (Z direction) with respect to the cart 10. As a result, the attachment portion 450 can be easily attached to the cart 10 (handle 104). In addition, since the traveling tool 40 for a cart can be detachably coupled to the cart 10 by the joining portions 451 and 452, a commercially available general cart can be used as the cart 10, and when the traveling tool 40 for a cart is not necessary, the traveling tool 40 for a cart can be easily removed from the cart 10.

The attachment portion 450 further includes a grip portion 453 and a transmission portion 454. The grip portion 453 is to he gripped by the user. The transmission portion 454 transmits, to the handle 104, an action taken on the cart 10 by the user, the action being input via the grip portion 453. As a result, the user can operate the cart 10 via the grip portion 453 and the transmission portion 454 of the attachment portion 450 without gripping the handle 104 of the cart 10. However, when the user grips the handle 104 of the cart 10 to operate the cart 10, the grip portion 453 and the transmission portion 454 are not essential in the attachment portion 450. Note that the grip portion 453 may be provided with a brake portion that applies resistance to rotation of at least either the wheel 420a or 420b provided on the deck portion 410 to decelerate or stop the traveling of the traveling tool 40 for a cart (deck portion 410). Furthermore, the power switch for turning on/off the drive of the motor 430 may he provided on the grip portion 453 instead of being provided on the deck portion 410.

As described above, according to the carrying tool 1B having a configuration in which the traveling tool 40 for a cart is attached to the cart 10, when the user grips the grip portion 453 of the attachment portion 450, and turns on the drive of the motor 430 while standing on (the footrest surface 412a of) the deck portion 410, at least either the wheel 420a or 420b provided on the deck portion 410 rotates to cause the traveling tool 40 for a cart (deck portion 410) to travel, and the cart 10 coupled to the deck portion 410 via the attachment portion 450 travels in conjunction with the traveling of the traveling tool 40 for a cart. Therefore, in the present embodiment, it is possible to reduce a load on the user at the time of carrying the object BG to be carried and improve user convenience (usability) as compared with a case where the user pushes the handle 104 of the cart 10 by hand (with the strength of the user's arms) while walking (a case where the traveling tool 30 for a cart is not attached). In addition, in the present embodiment, since (the carrying tool 1B including the traveling tool 40 for a cart and) the cart 10 is caused to travel by electric power, the time required for carrying, the object BG to be carried can be shortened, so that it is possible to significantly reduce user's fatigue caused by the carrying of the object BG to be carried. Furthermore, in addition to reducing a load on the user at the time of carrying the object BG to be carried, the carrying tool 1B according to the present embodiment also serves as a vehicle that provides enjoyment for the act of carrying the object BG to be carried that is more likely to be avoided than not.

### SUMMARY OF EMBODIMENTS

1. The travel tools for a cart, according to the above-described embodiments are traveling tools (for example, 30, 40) for a cart, each of the traveling tools being to be attached to a cart (for example, 10), the cart including a wheeled (for example, 106) platform (for example, 102) on which an object (for example, BG) to be carried is to be placed, the object to be carried being to be carried by a user pushing a handle (for example 104) provided in the rear of the platform, the traveling tools each including:

a deck portion (for example, 310, 410) extending in a first direction (for example, X direction) and including a board-like member (for example, 312, 412) that defines a footrest surface (for example, 312a, 412a) on which a foot of the user is to be placed;

at least one first wheel (for example, 320, 420b) provided in the rear of the deck portion, the at least one first wheel being attached to the board-like member in such a way as to be capable of rotating around an axis so as to enable the deck portion to travel, the axis being along a second direction (for example, Y direction) orthogonal to the first direction;

an operation pole (for example, 330, 440) provided on the front of the deck portion so as to enable the deck portion to he rotated around an axis with respect to the cart, the axis being along a third direction orthogonal to the first direction and the second direction; and

a coupling portion (for example, 340, 450) that is provided on the operation pole, and couples the deck portion to the cart.

According to these embodiments, it is possible to reduce a load on the user at the time of carrying the object BG to be carried and improve user convenience (usability).

2. In the above-described traveling tool (for example, 30) for a cart,

the board-like member (for example, 312) defines the footrest surface (for example 312a) such that the footrest surface has an enough area for the user to place one foot,

the at least one first wheel (for example, 320) is caused to rotate around the axis along the second direction by the user with one foot placed on the footrest surface and the other foot pushing against a ground surface with which the at least one first wheel is in contact, and

rotation of the at least one first wheel causes the deck portion (for example, 310) to travel, and the cart (for example, 10) travels in conjunction with traveling of the deck portion, the cart being coupled to the deck portion via the coupling portion (for example 340).

According to this embodiment, the time required for carrying an object to be carried can be shortened, so that it is possible to reduce user's fatigue caused by the carrying of the object to be carried.

3. The above-described traveling tool (for example, 30) for a cart, further includes:

a rotation portion (for example, 360) provided at one end of the deck portion (for example, 310), the one end being closer to the cart (for example, 10), the rotation portion being configured to enable the deck portion to rotate around an axis along the second direction with respect to the cart.

According to this embodiment, it is possible to fold the deck portion by rotating the deck portion in such a way as to position the deck portion close to the cart.

4. The above-described traveling tool (for example, 30) for a cart, further includes:

a fixing portion (for example, 370) that fixes, to the cart (for example, 10), the deck portion (for example, 310) rotated by the rotation portion (for example, 360) in such a way as to be positioned close to the cart.

According to this embodiment, it is possible to keep the deck portion compactly folded.

5. In the above-described traveling tool (for example, 30) for a cart.

the coupling portion (for example, 340) detachably couples the deck portion (for example, 310) to the cart (for example, 10).

According to this embodiment, it is possible to use a general cart, and also possible to easily remove the traveling tool for a cart from the cart.

6. In the above-described traveling tool (for example, 30) for a cart,

the coupling portion (for example, 340) is fixed to the operation pole (for example, 330).

According to this embodiment, it is possible to firmly couple the traveling tool for a cart to the cart via the operation pole.

7. The above-described traveling tool (for example, 30) for a cart, further includes:

a brake portion (for example, 350) that decelerates or stops traveling of the deck portion (for example, 310) by applying resistance to rotation of the at least one first wheel (for example, 320).

According to this embodiment, it is possible to easily control the deceleration or stopping of the traveling of the traveling tool for a cart.

8. The above-described traveling tool (for example, 40) for a cart, further includes:

at least one second wheel (for example, 420a) provided on the front of the deck portion (for example, 410), the at least one second wheel being attached to the board-like member (for example, 412) in such a way as to be capable of rotating around an axis along the second direction so as to enable the deck portion to travel; and

a motor (for example, 430) that causes at least either the at least one first wheel (for example, 420b) or the at least one second Wheel to rotate around the axis along the second direction.

in which rotation of the at least either the at least one first wheel or the at least one second wheel causes the deck portion (for example, 410) to travel, and the cart (for example, 10) travels in conjunction with traveling of the deck portion, the cart being coupled to the deck portion via the coupling portion (for example, 450).

According to this embodiment, the time required for carrying an object to be carried can be shortened, so that it is possible to reduce user's fatigue caused by the carrying of the object to be carried.

9. In the above-described traveling tool (for example, 40) for a cart, the coupling portion (for example, 450) includes an attachment portion (for example, 450) that is attached to the operation pole (for example, 440) and the handle (for example, 104), and couples the deck portion (for example, 410) to the cart (for example, 10).

According to this embodiment, it is possible to couple the traveling tool for a cart to the cart via the attachment portion.

10. In the above-described traveling tool (for example, 40) for a cart,

the attachment portion (for example, 450) is attached to the handle (for example, 104) such that the attachment portion can rotate around an axis along the third direction with respect to the cart (for example, 10).

According to this embodiment, it is possible to ensure rotational movement of the traveling tool for a cart in the right-and-left direction.

11. In the above-described traveling tool (for example, 40) for a cart,

the attachment portion (for example, 450) is detachably attached to the operation pole (for example, 140) and the handle (for example, 104).

According to this embodiment, it is possible to use a general cart, and also possible to easily remove the traveling tool for a cart from the cart.

12. In the above-described traveling tool (for example, 40) for a cart,

the attachment portion (for example, 450) includes: a grip portion (for example, 453) to be gripped by the user; and a transmission portion (for example, 454) that transmits, to the handle (for example, 104), an action taken on the cart (for example, 10) by the user, the action being input via the grip portion.

According to this embodiment, the user can operate the cart via the grip portion and the transmission portion of the attachment portion without gripping the handle of the cart.

13. The carrying tools (for example, 1A, 1B) of the above-described embodiments each include:

a cart (for example, 10) including a wheeled (for example, 106) platform (for example, 102) on which an object (for example, BG) to be carried is to be placed, the object to be carried being to be carried by a user pushing a handle (for example, 104) provided in the rear of the platform; and

a traveling tool (for example, 30, 40) fora cart, the traveling tool being to be attached to the cart,

in which the traveling tool for a cart includes:

a deck portion (for example, 310, 410) extending in a first direction (for example, X direction) and including a board-like member (for example, 312, 412) that defines a footrest surface (for example, 312a, 412a) on which a foot of the user is to be placed;

at least one first wheel (for example, 320, 4204) provided in the rear of the deck portion, the at least one first wheel being attached to the board-like member in such a way as to be capable of rotating around an axis so as to enable the deck portion to travel, the axis being along a second direction (for example, Y direction) orthogonal to the first direction;

an operation pole (for example, 330, 110) provided on the front of the deck portion so as to enable the deck portion to be rotated around an axis with respect to the cart, the axis being along a third direction orthogonal to the first direction and the second direction; and

a coupling portion (for example, 340, 450) that is provided on the operation pole, and couples the deck portion to the cart.

According to these embodiments, it is possible to reduce a load on the user at the time of carrying the object BG to be carried and improve user convenience (usability).

The invention is not limited to the foregoing embodiments, and various variations/changes are possible within the spirit of the invention.

What is claimed is:

1. A traveling tool for a cart, the traveling tool being to be attached to a cart, the cut including a wheeled platform on which an object to be carried is to be placed, the object to be carried being to be carried by a user pushing a handle provided in rear of the platform, the traveling tool comprising:
a deck portion extending in a first direction and including a board-like member that defines a footrest surface on which a foot of the user is to be placed;
at least one first wheel provided in rear of the deck portion, the at least one first wheel being attached to the board-like member in such a way as to be capable of rotating around an axis so as to enable the deck portion to travel, the axis being along a second direction orthogonal to the first direction;
an operation pole provided on front of the deck portion so as to enable the deck portion to be rotated around an axis with respect to the cart, the axis being along a third direction orthogonal to the first direction and the second direction; and
a coupling portion that is provided on the operation pole, and couples the deck portion to the cart.

2. The traveling tool for a cart according to claim 1, wherein
the board-like member defines the footrest surface such that the footrest surface has an enough area for the user to place one foot,
the at least one first wheel is caused to rotate around the axis along the second direction by the user with one foot placed on the footrest surface and another foot pushing against a ground surface with which the at least one first wheel is in contact, and
rotation of the at least one first wheel causes the deck portion to travel, and the cart travels in conjunction with traveling of the deck portion, the cart being coupled to the deck portion via the coupling portion.

3. The traveling tool for a cart according to claim 1, further comprising: a rotation portion provided at one end of the deck portion, the one end being closer to the cart, the rotation portion being configured to enable the deck portion to rotate around an axis along the second direction with respect to the cart.

4. The traveling tool for a cart according to claim 3, further comprising: a fixing portion that fixes, to the cart, the deck portion rotated by the rotation portion in such a way as to be positioned close to the cart.

5. The traveling tool for a cart according to claim 1, wherein the coupling portion detachably couples the deck portion to the cart.

6. The traveling tool for a cart according to claim 1, wherein the coupling portion is fixed to the operation pole.

7. The traveling tool for a cart according to claim further comprising: a brake portion that decelerates or stops traveling of the deck portion by applying resistance to rotation of the at least one first wheel.

8. The traveling tool for a cart according to claim 1, further comprising:
at east one second wheel provided on front of the deck portion, the at least one second wheel being attached to the board-like member in such a way as to be capable of rotating around an axis along the second direction so as to enable the deck portion to travel; and
a motor that causes at least either the at least one first wheel or the at least one second wheel to rotate around the axis along the second direction,
wherein rotation of the at least either the at least one first wheel or the at least one second wheel causes the deck portion to travel, and the cart travels in conjunction with traveling of the deck portion, the cart being coupled to the deck portion via the coupling portion.

9. The traveling tool for a cart according to claim 8, wherein the coupling portion includes an attachment portion that is attached to the operation pole and the handle, and couples the deck portion to the cart.

10. The traveling tool for a cart according to claim 9, wherein the attachment portion is attached to the handle such that the attachment portion can rotate around an axis along the third direction with respect to the cart.

11. The traveling tool for a cart according to claim 9, wherein the attachment portion is detachably attached to the operation pole and the handle.

12. The traveling tool for a cart according to claim 9, wherein the attachment portion includes: a grip portion to be gripped by the user; and a transmission portion that transmits, to the handle, an action taken on the cart by the user, the action being input via the grip portion.

13. A carrying tool comprising:
a cart including a wheeled platform on which an object to be carried is to be placed, the object to be carried being to be carried by a user pushing a handle provided in rear of the platform; and
a traveling tool for a cart, the traveling tool being to be attached to the cart,
wherein the traveling tool for a cart includes:
a deck portion extending in a first direction and including a board-like member that defines a footrest surface on which a foot of the user is to be placed;
at least one first wheel provided in rear of the deck portion, the at least one first wheel being attached to the board-like member in such a way as to be capable of rotating around an axis so as to enable the deck portion to travel, the axis being along a second direction orthogonal to the first direction;
an operation pole provided on front of the deck portion so as to enable the deck portion to be rotated around an axis with respect to the cart, the axis being along a third direction orthogonal to the first direction and the second direction; and
a coupling portion that is provided on the operation pole, and couples the deck portion to the cart.
